(19) United States
(12) Patent Application Publication
(10) Pub. No.: US 2010/0229662 A1
(43) Pub. Date: Sep. 16, 2010

(54) Instrumentation and Monitoring System For Pipes and Conduits Transporting Cryogenic Materials

(76) Inventor: David V. Brower, Houston, TX (US)

Correspondence Address: Robert C. Curfiss, 19826 Sundance Drive, Humble, TX, 77346-1402, US

(21) Appl. No.: 12/619,610

(22) Filed: Nov. 16, 2009

Related U.S. Application Data
(63) Continuation-in-part of application No. 12/150,425, filed on Apr. 28, 2008.
(60) Provisional application No. 60/914,756, filed on Apr. 29, 2007.

(51) Int. Cl. G01M 19/00; G02B 6/44

(52) U.S. Cl. 73/865.8; 385/100; 138/104

(57) ABSTRACT

An instrumentation and monitoring system for a cryogenic material transfer system incorporates a pipe-in-pipe configuration with either a vacuum or a nanoporous or microporous insulating layer filling the annulus between the inner and outer pipe. The insulating layer is of sufficient flexibility to absorb the expansion or contraction of the inner pipe due to thermal effects from the flow of cryogenic material. The monitoring system typically includes a multitude of fiber optic sensors that measure leaks, temperature, pressure and strain. The invention includes the fiber optic sensors, conventional sensors, cabling, connectors/splice assembles, ingress/egress methods, ruggedization methods, data acquisition and analysis.

### CROSS REFERENCE TO RELATED APPLICATION

This application is a continuation-in-part of U.S. patent application Ser. No. 12/150,425, which was filed on Apr. 28, 2008, which claims priority under U.S. Provisional Application No. 60/914,756, which was filed on Apr. 29, 2007, both of which are incorporated herein by reference.

### BACKGROUND OF THE INVENTION

1. Field of the Invention

The invention is generally related to instrumentation methods for monitoring and measuring temperature, pressure, leaks and mechanical properties in pipes or conduits for carrying cryogenic materials and is specifically directed to a pipeline system including fiber optic sensor instrumentation systems and methods.

2. Discussion of the Prior Art

Pipeline transfer of cryogenic fuels and other liquids such as liquid natural gas (LNG) is commonplace throughout the world. In fact, LNG is currently the fastest growing hydrocarbon fuel in the world. While gas as a primary fuel source is forecast to grow at 3% in the coming two decades, LNG is forecast to grow at double that rate over the same period. This growth will result in the need for additional facilities for the production and transportation of LNG in the foreseeable future, and as a result new technologies will emerge to address cost, safety and reliability issues that this expansion may create.

For example, LNG loading into the tankers and the offloading thereof, require the use of terminals designed to handle the LNG. Terminals at the loading site are normally close to the liquification plant and traditionally on the offloading end, and the terminal is typically situated near a storage facility and re-gasification plant. Proximity of the onshore terminals to water access has prompted a review of increased shipping traffic in congested waterways. As terminal siting concerns build over pressures from environmental and public safety issues, there is a trend to reconsider moving terminal locations offshore.

Given that both production and import of LNG will move more and more offshore, there is a growing need for a safe, efficient and reliable transfer system. Beginning in the 1970's, a sub sea LPG pipeline was designed for a Middle Eastern LPG terminal. This continued into the 1980's with the first sub sea LNG pipeline for an arctic LNG ship system in Alaska.

Terminals are required for both the loading of LNG into the tankers and for offloading thereof. For locations with sufficient deep water access close to the coast, terminals may consist of jetty structures and breakwaters, where tankers can be moored and offloading can take place via the standard loading arms.

When conditions are less favorable due to shallow waters, congested shipping and/or mooring situations, or because of lack of community acceptance and permitting difficulties, offshore terminals are a very attractive alternative. Although such terminals exist—they have been widely used for loading of crude oil and oil products for many years—no offshore terminals for LNG are in use.

The most dominant advantages of LNG offshore terminals are the lower costs for construction and operation, the possibility to locate the terminal in deeper water thereby eliminating the need for dredging and increased availability, safety and reduced voyage time as LNG carriers need not enter and maneuver in congested waters. LNG carrier berths can be located away from confined waterways, thereby increasing both safety and also security, while at the same time reducing costly civil works. Furthermore, impairment of other new and existing shipping traffic will be minimized.

A sub sea pipeline or one supported by a trestle can be used to transport the LNG from/to an offshore terminal. With current sub sea cryogenic pipeline designs, LNG can be efficiently transferred over distances exceeding 20 miles.

Current pipeline technologies for cryogenic products, such as LNG, use both flexible hoses and rigid pipe. The former is limited to short-distance loading and offloading hoses because of the high expense and the limitation of insulation that can be provided. For longer distance pipelines, rigid pipelines must be used. Current configurations and methods for rigid cryogenic pipelines typically involve the use of a pipe-in-pine arrangement consisting of low pressure or vacuum environments in an insulating space around a product pipeline to achieve the desired thermal performance characteristics. While low pressure or vacuum systems can provide excellent insulation, operation and maintenance of such systems tends to be costly, and frequently becomes problematic where such pipelines are submerged on, or even below the sea bed. A second method of insulation includes an insulating material, such as aerogel or thermal foams. Both configurations typically involve a pipe-in-pipe or even three pipe-in-pipe assemblies.

Other difficulties are also often encountered, most typically associated with thermal expansion/contraction due to cooling, compression and/or structural stability. For example, one current technology accommodates the contraction by the use of INVAR™ (36% Nickel Steel), which has very low expansion and contraction properties. In such a configuration, the INVAR™ product transportation line is contained within an external steel casing pipeline with a partial vacuum or aerogel as the insulated annulus. While thermal expansion is minimized, various disadvantages nevertheless remain. For example INVAR™ steel is relatively expensive and often cost prohibitive. Moreover, generation and maintenance of the low pressure (e.g., 100 mbar) in the pipeline assembly requires considerable maintenance and cost over the life of the pipeline.

Other pipe materials such as 9% Nickel have application. This material has good thermal expansion properties and is often less costly than Invar. 9% Nickel has been identified for use in pipe-in-pipe systems that incorporates bulkheads to account for thermal strain.

In other known configurations, contraction and expansion capabilities are improved with the use of bellows. This configuration incorporates the use of bellows, one in each segment (about 50 ft long) of the pipeline, which is a self-contained pipe-in-pipe segment, and uses vacuum insulation. However, the use of bellows along the length of pipeline typically increases production costs, and typically complicates manufacture, handling and maintenance. The bellows methods are generally more costly than the INVAR™ system. The bellows method has significant disadvantages in reliability and durability, both with the bellows and with the maintenance of vacuum. For a sub sea application, reliability and durability are even more critical. Regardless of the pipe configuration, an effective monitoring system should be displayed. This system should measure temperature, pressure, structural properties and leaks. Leaks are of concern in the annular space and the exterior of the pipeline. The most likely material used as the Conduit is but not limited to:

Invar

Type 316 stainless steel (ASTM A3 12)

9Ni Steel (ASTM 333 Grade 8 pipe)

Composite pipe such as graphite/epoxy or Kevlar/epoxy

### SUMMARY OF THE INVENTION

The subject invention is directed to instrumentation of pipelines for transporting material at sub-ambient temperature and especially cryogenic material constructed in a manner such that the pipeline has both increased mechanical stability and desirable thermal insulation properties while maintaining a mechanically simple structure. The configurations of the subject invention are relatively inexpensive to manufacture and install. The configurations embody these desired characteristics by the incorporation of an instrumented system for monitoring a pipeline including a silica aerogel (or other insulating material) or vacuum system contained in a pipe-in-pipe environment that is designed as a structural element.

The monitoring system of the subject invention incorporates ruggedized sensors, cabling, deployment hardware, ingress/egress apparatus, data acquisition, software and analysis. The system includes full redundancy in the monitoring zones and provides constant monitoring in real-time with computer interfaces. A complete determination of the Cryogenic pipeline condition is continuously available and may be accessed instantly by operators. Data is analyzed and displayed with real-time computer/software algorithms to determine temperature, pressure, leaks, thermal and mechanical strain, intrusion, service-life and can identify potential problems as they occur.

Monitoring during startup and shut down operations provides a complete temperature and strain profile of the entire pipeline length. The analysis eliminates guesswork and provides operators with necessary information to ensure reliability, operational standards and identify and implement corrective action early, permitting both, significant cost savings and also the prevention of potential operational problems. A method of obtaining redundant data is also disclosed. This extends the monitoring system life and provides alternate data retrieval routes in the event of pipeline or cable damage.

Particularly preferred materials for an LNG product pipeline comprises 36% nickel steel or 9% nickel steel, while the outer pipeline comprises carbon steel. The preferred thermal insulation comprises a high performance nanoporous aerogel product in blanket or bead form installed within the annular space, typically at ambient pressure. Such aerogels may be applied in any form; however, preferred forms include flexible sheets, or spray-coated materials.

The monitoring system consists of several types of fiber optic sensors. Both distributed and local sensing are included in the overall system. The local sensors are high resolution devices. The distributed sensors may be slower in acquisition speed, but adequate to locate leaks and provide temperature profiles within approximately a degree Centigrade at one meter resolution over the length of the pipeline. In addition to fiber optic sensors the invention may incorporate conventional sensors such as thermocouples, RTD's, pressure transducers resistive strain gages.

In the preferred embodiment each pipeline monitoring system includes:
Temperature along the entire inner pipe
Leak detection throughout the inner annular space and exterior of the pipeline
Pressure in the annular space and along any vent lines
Structural monitoring in regions such as the bulkhead and near selected welds or other regions of structural interest
Intrusion detection

Additionally, the support structure of the pipeline system may undergo structural monitoring. Multiple of the structural members are instrumented with sensors to verify mechanical integrity. Multiple sensing regions are incorporated into the design and conduits containing fiber optic sensors will be installed adjacent to the exterior of the inner pipe. OTDR distributed sensor measurement will be redundant and will determine temperature along the entire distance of the LNG/multi-product/NGL cool-down pipe lengths.

Temperature and leak detection will likewise involve distributed sensing methods. Ruggedized cables will be installed within the regions around the aerogel expansion packs or the vacuum annuals. Additionally, distributed sensors may be placed on the exterior of the pipelines. These sensing elements will determine possible leaks from the outside pipe. The fiber also acts as detection sensors for unwanted intrusion such as anchor drops or intentional. Pressure measurements are typically achieved by Fabry Perot sensors, Fiber Bragg Gratings or by distributed methods.

While the disclosed cryogenic pipeline configurations and methods are preferably employed for LNG offloading and offshore LNG terminals, numerous alternative uses are also considered suitable. For example, alternative uses could include transfer lines for floating LNG production, storage, and offloading vessels, liquid hydrogen and oxygen fueling lines for aerospace or other applications, and all applications that need to transport cryogenic products through pipelines. Additionally, other uses include LPG transport, or transport of gases and liquids having a temperature below ambient temperature (e.g., liquefied carbon dioxide, LPG, liquid nitrogen, and the like).

Other uses, advantages and feature of the subject invention will be readily apparent from the accompanying drawings and description of the preferred embodiments.

### BRIEF DESCRIPTION OF THE DRAWINGS

FIG. 1 is a perspective view of the insulated cryogenic pipeline configuration of the subject invention.

FIG. 2 is a cutaway view of a metallic bulk head at a field joint.

FIG. 3 is a cutaway view of a non-metallic bulkhead.

FIG. 4 is similar to FIG. 1, with a fiber optic sensor system installed in the annulus between the internal pipe and the external casing.

FIG. 5 is an overview of a typical fiber optics instrumentation method as used in accordance with the subject invention.

FIG. 6 is an overview of a typical optics instrumentation method as used in accordance with the subject invention.

FIG. 7 is a diagram of a Fiber Bragg Grating (FBG) fiber optic sensor configuration.

FIG. 8 is an illustration of a distributed sensing system consisting of stimulated Brillouin scattering, wherein the Brillouin frequency at each point in the fiber is linearly related to the temperature and strain that is applied to the fiber.

FIG. 9 is a diagram of the monitoring system layout.

FIGS. 10, 11 and 12 are diagrammatic views of the LNG pipeline assembly.

FIGS. 13 and 14 are diagrammatic views of the product pipeline assembly.

FIGS. 15 and 16 show the routing of the temperature sensors along the longitudinal axis of the LNG pipe assembly.

FIG. 17 is an illustration of the bulkhead assembly, similar to FIG. 2, showing the position of the bulkhead sensors.

FIG. 18 illustrates the positions of the PLET monitoring sensors.

FIG. 19 is a cross-section of the leak detection cable.

FIG. 20 is a cross-section of the temperature monitoring cables.

FIG. 21 is a view of the bulkhead cable egress system.

### DETAILED DESCRIPTION OF THE PREFERRED EMBODIMENTS

The major components and design criteria of the monitoring system are as follows:
Multiple pipelines. For purposes of discussion, two LNG pipelines, 8 km in length will be discussed, containing multiple fiber optic lines for temperature, pressure, leaks and strain monitoring. The remaining components listed here are consistent with the example of two LNG pipelines, 8km in length. It should be understood that the teachings of the invention can be incorporated in additional multiple pipeline configurations of varying length and the following components would be modified to correspond to the specific configuration. The described example should not be considered as limiting, but merely exemplary.
Two multi-product lines, 8 km in length containing multiple fiber optic lines for temperature, pressure, leaks and strain monitoring.
One NGL cool-down line, 8km in length containing multiple fiber optic lines for temperature, pressure, leaks and strain monitoring.
Leak detection sensing fibers that are placed on the upper part of each of the five pipelines to measure outside pipe leakage and intrusion from external sources.
Cable attachment hardware.
Detection of intrusion, inadvertent or intentional.
Temperature mapping analysis and display.
Data acquisition, signal conditioning, software and system integration.
Interface monitoring software with overall LNG facility.
Cabling ingress/egress, breakouts and terminations.
Ruggedization and robustness of sensing system.
Long life of 30 years.
Identification of fiber types and transmission and attenuation requirements.
Protection of fiber from chemical attack including hydrogen infusion.

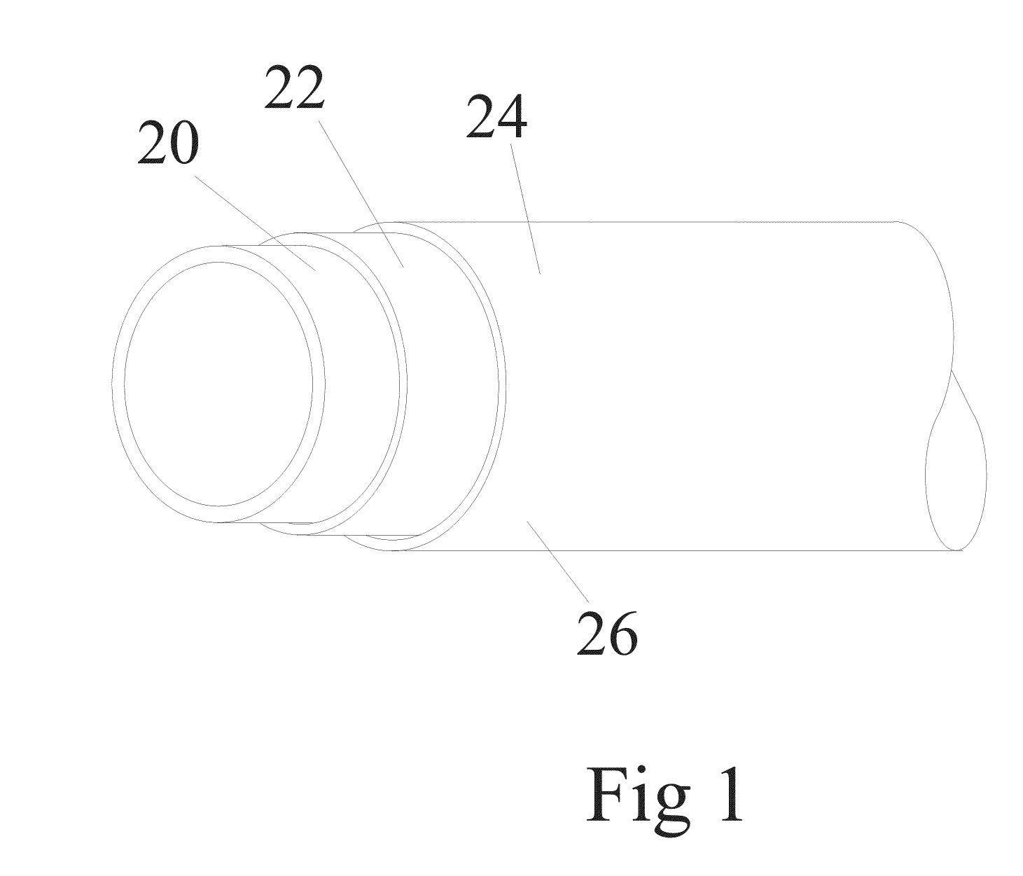

The subject pipeline technology uses either a vacuum or a highly efficient thermal nanoporous insulation in the annular space between the inner and outer pipes and this material is generally kept in an ambient pressure environment. Where leak detection is employed, the pressure may be slightly above ambient pressure. As shown in FIG. 1, the internal cryogenic product pipe for LNG vapor or LPG service is a rigid pipe such as, by way of example the ASTM 333 Grade 8, 9% nickel steel pipe 20. This is surrounded by a nanoporous insulation material 22 which fills the space between the external casing pipe 24, which may be a carbon steel pipe with FBE corrosion coating, and the internal pipe 20. The insulation is typically a flexible aerogel. There is no need for a water stop commonly required in common insulation systems, as the aerogel insulation is contained within a Tyvek™ or similar outer wrapping and the aerogel is by definition hydro-phobic. The inner and outer pipes are connected with non-metallic or metallic bulkheads. An external concrete weight coating 26 or the like may be applied if desired or required in specific installations.

The subject invention is used for cryogenic pipelines involve the use of low pressure or vacuum environments to achieve the thermal performance characteristics of the insulation systems. The subject invention is also used for the disclosed LNG pipeline technology that utilizes the highly efficient insulation 22 in an ambient environment. The nanoporous insulation is hydro-phobic, in that the pore spaces are smaller than water molecules. Therefore, the insulation does not absorb water and the insulation does not degrade in the presence of water or moisture, an important consideration for thermal efficiency and for operational maintenance.

One of the novelties of one of the LNG pipeline technologies is the application of non-metal bulkheads and spacers, metallic bulkheads or hybrid bulkheads and spacers to cryogenic product pipelines such as those transporting LNG. The resulting pipeline bundle configuration is a structural element, which addresses the thermal contraction and expansion loads without resorting to expansion bellows or ultra-low thermal contraction alloys. The method eliminates the need for both the expensive alloys and the vacuum pipe-in-pipe. The bulkheads transfer the contraction induced axial compression load on the inner cryogenic carrier pipe(s) to the external jacket pipe. The pipe(s)-in-pipe system functions as a structural column, with thermal insulation maintained in the annular space in an ambient pressure environment.

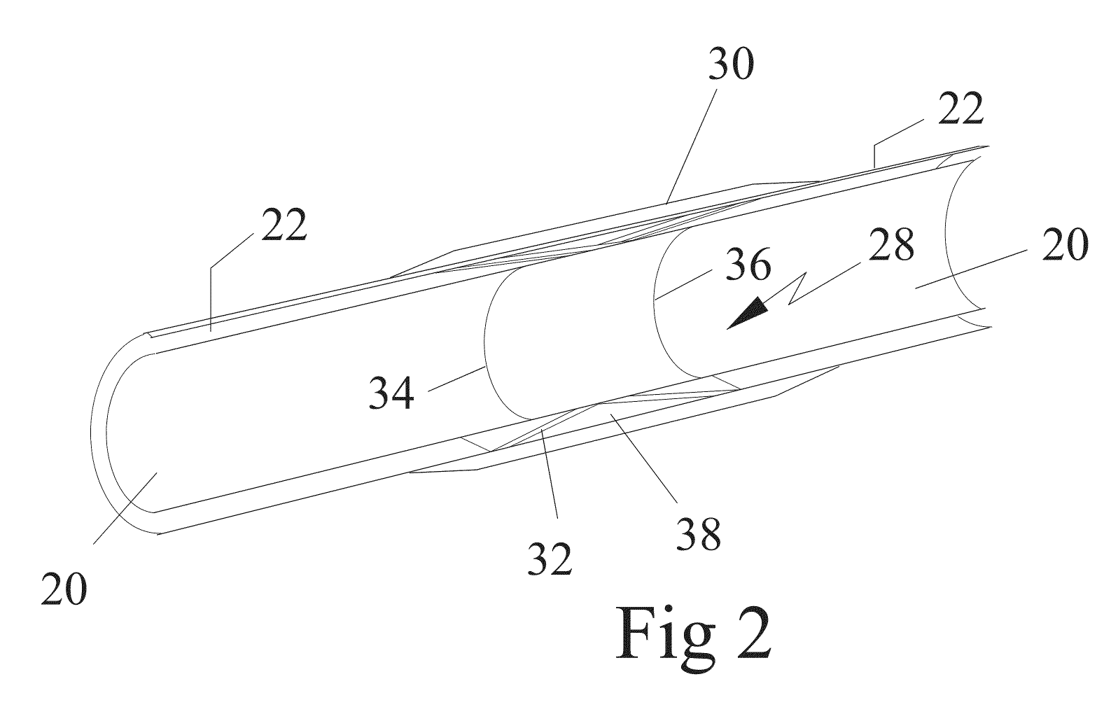

Metallic bulkheads are used at the ends to effect sealing of the annular space and to allow transfer of the contraction inducted axial compression load, see FIG. 2. As there shown, the bulkhead consists of a pipe-in-pipe joint 28. A prefab transition 32 is provided for receiving the two pipe ends 34, 36. A split sleeve 38 is positioned between the two pipe ends 34, 36 and held in position by the prefab transition 32. External insulation 30 may be applied at the joint where required.

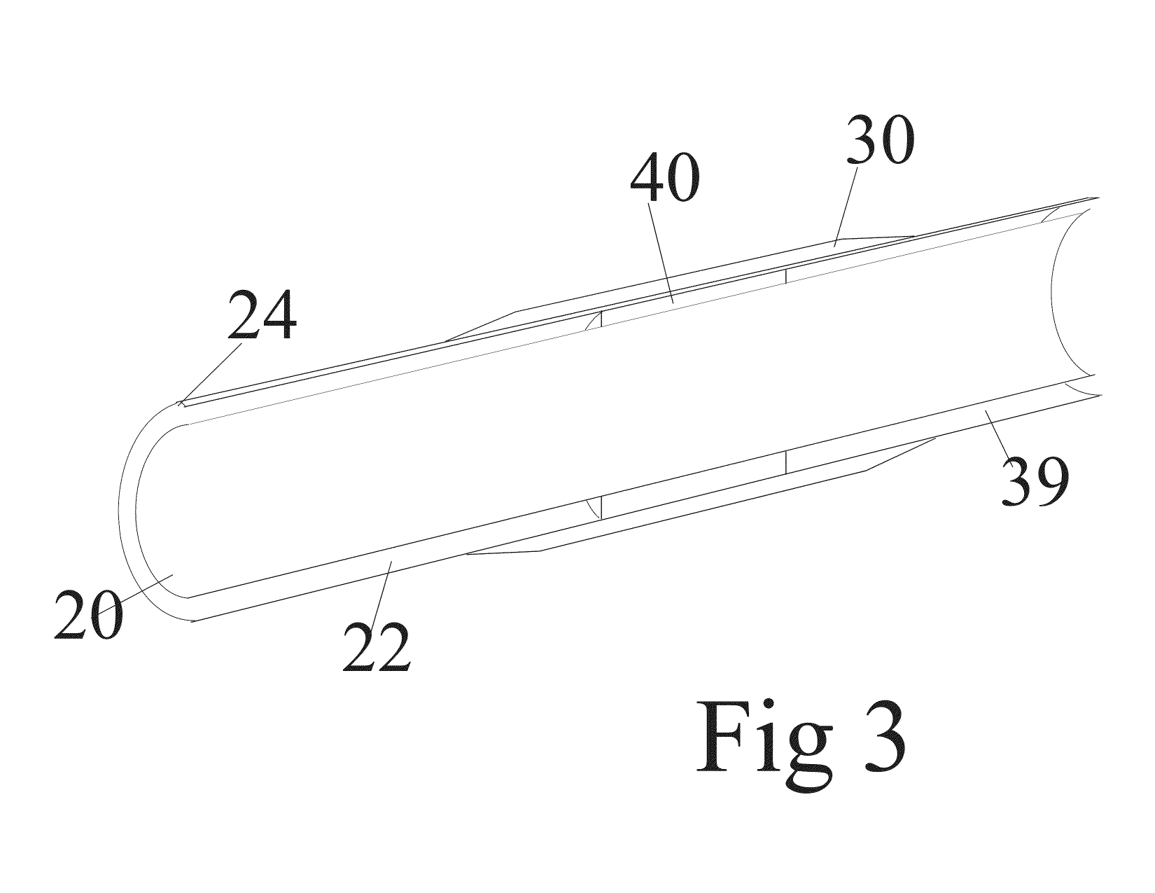

As shown in FIG. 3, non-metallic bulkheads 40 are used throughout the pipeline configuration to provide additional sealing or water stops and to provide additional load transfer. These non-metallic bulkheads are used to transfer thermal contraction and growth loads from the inner pipe to the outer pipe.

By way of example, a LNG carrier pipe that would be rated for cryogenic service and the transfer thermal loads imparted through the bulkheads would be a 9% Nickel steel, while the jacket pipe is carbon steel, and the thermal insulation is a high performance nanoporous aerogel product in blanket or bead form installed within the annular space without vacuum and under ambient pressure. Whereas 36% Nickel steel systems are typically used in other pipeline configurations. Both are candidates for the subject invention/instrumentation monitoring system.

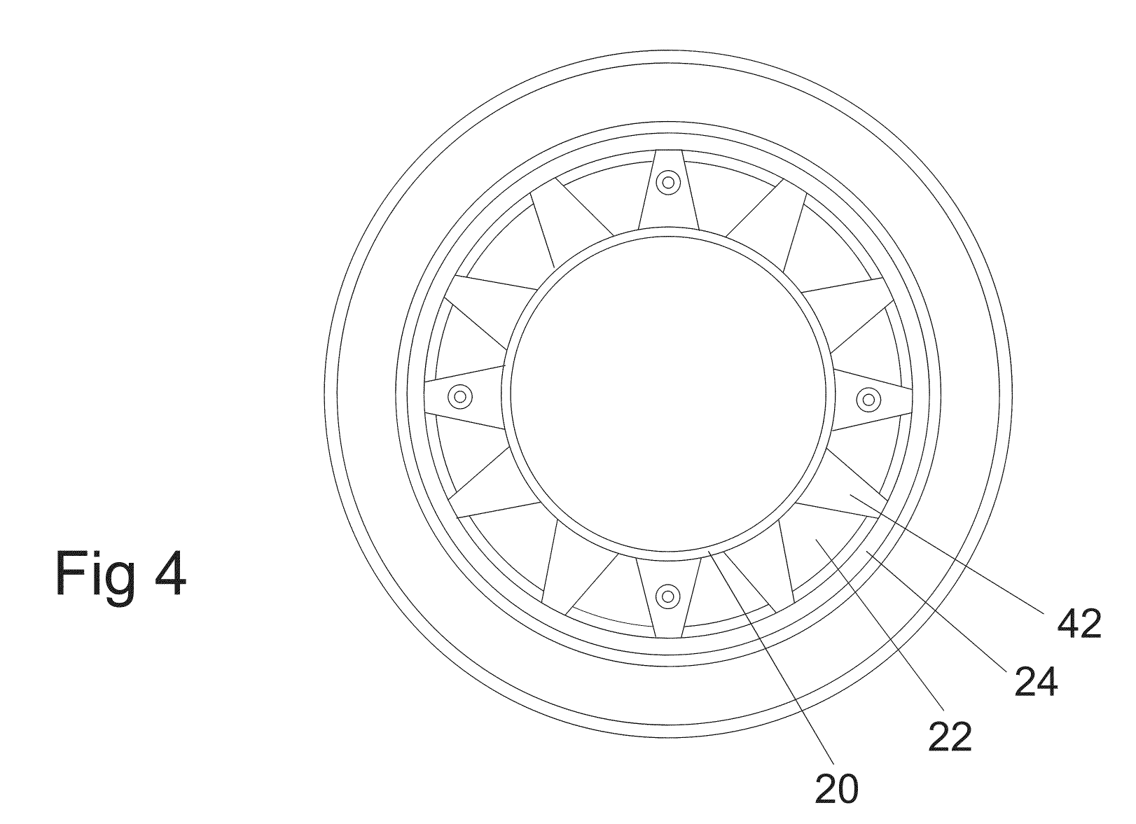

As shown in FIG. 4, spacers 42 are also installed in the annular space between the internal and external pipe to transfer loads by friction and/or shear. The spacers may be of either a metallic on non-metallic construction, preferably a polymer or metal capable of absorbing the thermal loads created by the difference in temperature of the inner pipe and outer pipe. Preferably a water stop is incorporated in the design. This may be an integral feature of the bulk heads. External insulation 30 may be provided at the joint when required. The spacers are positioned axially along the length of the pipes between the bulkheads. This not only provides additional support and structural rigidity but also facilitates fabrication.

By way of example, a LNG carrier pipe that would be rated for cryogenic service and the transfer thermal loads imparted through the bulkheads would be a 9% Nickel steel, while the jacket pipe is carbon steel, and the thermal insulation is a high performance nanoporous aerogel product in blanket or bead form installed within the annular space.

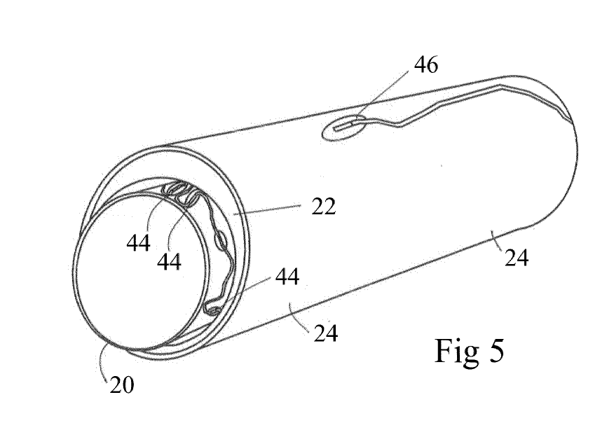

As shown in FIG. 5, consideration has been given in the design to a system to monitor the pressures and temperatures within the cryogenic carrier pipe and in the annular space to monitor the efficiency of the thermal insulation and to monitor and detect for internal leaks or for external internal interference from a security point of view. In the preferred embodiment, a fiber-optic real-time monitoring system has been developed that provides a means during operation and maintenance to monitor the cryogenic pipeline. As shown in FIG. 4 the fiber optic sensor system 44 In the annulus between the inner pipe 22 and the outer casing 24, preferably installed on the external wall of internal pipe 20. The sensor system 44 provides a means for monitoring heat-flux, temperature, pressure and strain on the internal pipe. A coupler 46 is attached to the outer pipe or casing 24 for receiving the inputs from the fiber optic sensors 44 and transmitting them to a monitoring station (not shown).

Installation of pre-fabricated and assembled pipelines can be done by numerous known methods, and especially include the towed method of installation. Alternatively, the pipeline may also be installed by a surface barge. The final method of installation would depend upon the final configuration of the pipeline and the resultant weight for the specific site application.

The pipeline's internal diameter is sized to handle the flow requirements for discharging the LNG tankers within the time frame required. Pipeline wall thickness is normally chosen with a Diameter/Thickness ratio under 50 for construction. All thicknesses used are intended to allow the pipeline to be operated at the low pressures expected.

If a longer tie-back to an onshore site is required, it is possible to extend the maximum length beyond 10 miles by changing the LNG product from a low pressure flow to a higher dense phase pressure flow that keeps the LNG within a range to minimize vapor boil off. This configuration requires an increase in the product transfer pipeline wall thickness and a subsequent change in the overall design, with a corresponding reduction in insulation requirements.

The key to the selection of a sub-sea cryogenic pipeline configuration is the consideration given to how the pipeline section can be fabricated and installed for the particular application, as each line must be designed for a site specific application. The pipe-in-pipe configuration chosen is similar to the bundled pipeline configurations that have been installed through-out the world over the last 20-years, so the construction techniques used are familiar to the marine construction industry. These techniques were pioneered in the Gulf of Mexico and North Sea.

Monitoring instrumentation is a key element in the present overall LNG pipeline configuration to address the issues of safety and security in the transport of cryogenic materials in a sub sea environment. Fiber optic sensors provide real-time strain, temperature, vibration, and flow monitoring for cryogenic LNG pipelines. Fiber optic sensors are attractive in these applications because of their multiplexing capability, immunity to electro-magnetic interference, ruggedness and long distance signal transmission ability.

Key features of fiber optic sensor are listed below:
Are lightweight and small in size.
Are rugged and have a long life—sensors will last indefinitely.
Are inert and corrosion resistant.
Have little impact or no impact on the physical structure.
Can be embedded or bonded to the exterior.
Have compact electronics and support hardware.
Can be easily multiplexed, significantly reducing cost and top side control room power and space.
Have high sensitivity.
Are multifunctional—they can measure strain, temperature, pressure, and vibration.
Require no electric current and are immune to electromagnetic interference (EMI).
Are safe to install and operate around explosives or flammable materials.

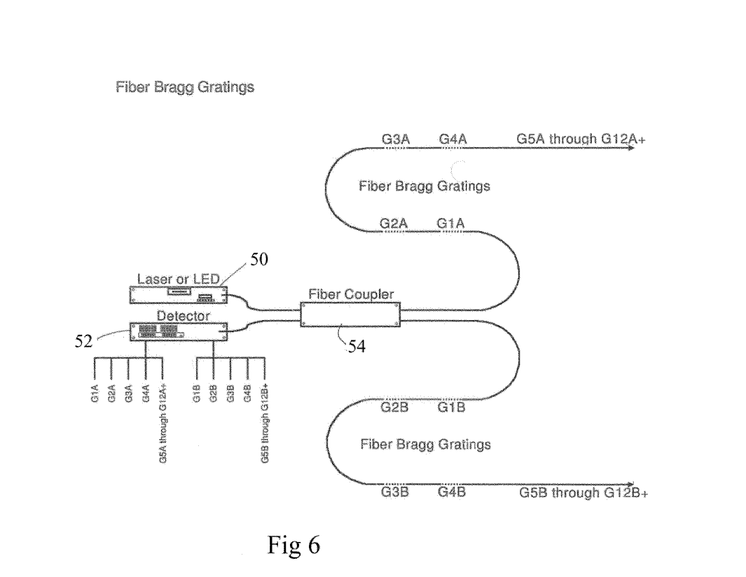

An overview of typical fiber optics instrumentation method is shown in FIG. 6. As there shown, multiple Laser or LED light source and detectors 50, 52 are coupled via a fiber coupler 54 with the “A” set of gratings passing through a first fiber optic cable and the “B” set of gratings passing through a second fiber optic cable. The number of detectors, gratings and grating sets and cables is arbitrary, and in the example is consistent with the Fiber Bragg Gratings methodology.

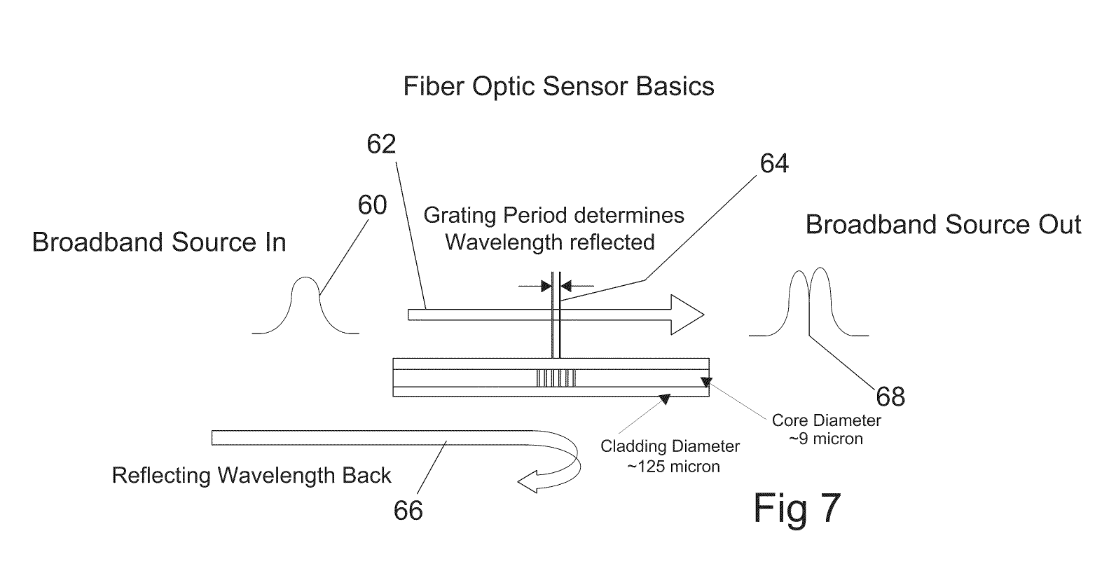

An exemplary system utilizing the teachings of the subject invention is shown in FIGS. 7-26. The monitoring system of the subject invention allows measurements to be taken along the entire length of the fiber plus at discrete points. These measurements provide monitoring of the complete temperature profile, thermal and mechanical strains, pressure in the annular space, leaks from both the inner and outer pipes, and intrusion.

Monitoring of temperature and strain is continuous over the duration of the pipeline life. During startup and shutdown operations the monitoring system measures and displays the temperature profile along the entire length of the pipeline and differential temperatures within the cross section of pipe.

The system measures strain, temperature and pressure over very long distances (currently 100 km) in real-time. In the event of a leak, an alarm will report within a few seconds (˜2 sec) that a leak is present. Within approximately two minutes the leak location can be identified within several meters. The distributed sensing system operates by gathering backscattered light from laser pulses. If the system runs another few minutes it will resolve the location to within a one meter location. However, almost all important data will be available within two minutes to implement corrective action.

An important element of this system is that even with a break in the fiber optic lines no data will be lost. Redundancy is a built in feature and a data acquisition system can be placed at either end of the pipe. A continuous loop or a return segment of fiber is not necessary.

Key features of the system are:
Uses standard telecom fibers.
Measures temperature, strain and pressure both distributed and locally.
High resolution and accuracy.
Long distance measurements well in excess of 8 km possible (up to 100 km/60 mi.) with no repeaters.
Multiplexing easily accomplished.
Integrated data acquisition system.
Monitoring can occur from either end of the pipeline so even with damaged or broken fibers monitoring will be unaffected.
Redundancy built into system.
Ruggedized to minimize risk of damage during handling and installation.
Measures leaks from inside and outside pipeline.
Measures pressure inside annulus.
Measures strain in regions of bulkhead and selected welds.
Inadvertent or intentional intrusion detected.

The sensor system consists of a combination of optical sensing distributed methods plus an array of fiber Bragg gratings (FBG's) and Fabry Perot (FP). Distributed methods measurements utilize a method to stimulate the Brillounin scattering of light within the fibers that allows for a determination of temperature variations at any location along the 8 km pipelines. Raman back scattering may also be used. It is also possible to determine distributed strain effects using the distributed method. Each FBG sensor array consists of multiple individual sensors on a particular fiber optic line. These are strategically placed along the pipeline.

Alternate distributed methods include Raman spectral analysis. The Brillounin offers the advantage of isolation of strain from the temperature measurements. For this LNG application it is the better choice.

Ruggedized fiber optic cables will be used to communicate the optical signal to the top side data acquisition system. The sensors may be encapsulated in a small diameter stainless steel tube. The tube may be filled with a conductive gel. The gel is designed for low temperature operation and contains H₂ scavengers to lessen possible attenuation from fiber darkening. Alternately, the stainless steel tube can contain no gel and includes only the optical fibers.

The cable will be ruggedized with steel reinforcement and a polyethylene or other outside polymer jacket such as polyurethane. It is similar in construction to those of proven reliability on other deepwater projects. The temperature, pressure and strain sensors will be of similar construction that have been reliability demonstrated in deepwater projects. These sensors have been in continuous use for several years at a depth of approximately 7500 feet and lengths of approximately 60 miles.

A computer and fiber optic based interrogators are used to interpret the fiber optic sensor data. The overall data acquisition system evaluates data from all fiber optic sensors including but not limited to distributed methods, Fiber Bragg Gratings (FBGs) and Fabry Perot sensors. The interrogator allows for continuous temperature, pressure, strain and leak detection monitoring over any specified time period. The basic FBG fiber optic sensor configuration is shown in FIG. 7. As there shown, the broadband source IN 60 is indicated as entering the sensor on the left as shown, and traveling in the direction of arrow 62. As indicated at 64, the grating period determines the wavelength which is reflected, see the reflected wavelength indicator 66, resulting in a broadband source out as indicated at 68. It should be noted that the reflected signal is detected at the input end of the fiber. Consequently only one end of the fiber requires access. Multiple gratings (sensors) can be placed on a single fiber, enabling high sensor count per fiber channel.

FBG sensors are ideal for temperature, strain, and pressure measurement. The sensors detect and reflect a certain wavelength of light within a broad bandwidth. When temperature is introduced, the reflected wavelength shifts. This wavelength shift is directly related to thermally induced strain and a change in the refractive index of the fiber. Wavelength division multiplexing (WDM), frequency division multiplexing (FDM), time division multiplexing (TDM) and other multiplexing methods are part of this invention. For illustration purposes WDM methods are discussed.

The grating wavelength is sensitive to temperature and dimensional changes in the fiber. The instrumentation senses the reflected frequencies and, in turn, determines the temperature or strain. FBG sensors provide a means for local temperature and strain measurements. Grating can be incorporated at any position along the fiber length. To measure response the fiber is exposed to an interference pattern of coherent light. A permanent grating is set up with the interference pattern and each grating is designed to reflect certain wavelengths.

The FBG sensor relies on the narrow band reflection from a region of periodic variation in the core index of refraction of a single-mode optical fiber. In this sensor, the center wavelength of the reflected signal is linearly dependent on the product of the scale length of the period variation (the period) and the mean core index of refraction. Changes in temperature or strain to which the optical fiber is subjected will consequently shift this Bragg wavelength, leading to a wavelength-encoded optical measurement.

Fiber-optic sensors have several distinct advantages. Only light passes through the fiber. There is no need for electrical current in the optical fiber portion of the instrumentation. Consequently, they are inherently safe since no electric field is present around flammable material such as hydrocarbons. They are immune to electromagnetic interference (EMI). The sensors are very sensitive and can easily sense fatigue, strain, temperature, pressure, vibration, or acoustic response. They are corrosion resistant to most materials. They are small, lightweight, and can either be embedded in the structure (such as composites) or bonded to the surface. The size of the fiber-optic sensor (250 nanometers, or approximately the diameter of a human hair) lends it to non-invasive usage. They have a long life and can provide continuous monitoring for long periods of time. Fiber-optic sensors can be used in environments where conventional sensors are not practical. Hundreds of sensors can be multiplexed into a single data acquisition unit. These are big advantages over electrical sensors.

The number of sensors that can be monitored by a single data acquisition system can be substantially increased with the introduction of time division multiplexing (TDM). This can be accomplished by the addition of optical switches to scan several sets of WDM sensors. Hundreds of sensors can be multiplexed using this system. The length of a structure is not a problem; miles of structure can be assessed without signal loss.

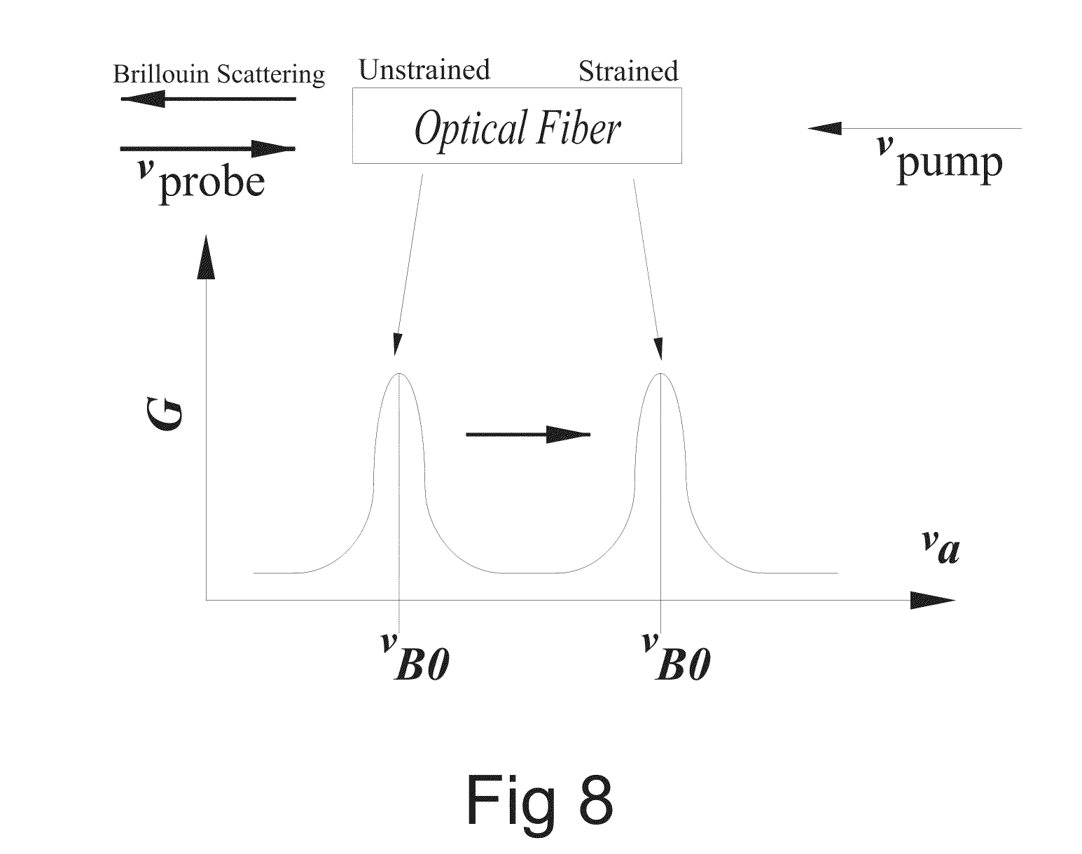

The distributed method portion of the monitoring system uses a phenomenon of stimulated Brillouin scattering. Raman backscattering can be used as well. This is illustrated in FIG. 8. The Brillouin frequency at each point in the fiber is linearly related to the temperature and strain that is applied to the fiber. The typical sensor configuration uses two lasers that are directed in opposite directions through the fiber. One laser is continuously operating and the other laser is pulsed. When the frequency difference between the two lasers is equal to the Brillouin frequency, there is a strong interaction between the two laser beams inside the fiber and the photons generated in the fiber. This interaction causes a strong amplification of the Brillouin signal which is detected through the signal conditioning equipment. The fitting of the peak of the spectrum provides the temperature and strain information. The distributed methods may incorporate fibers integrated from a single end, or may contain a return loop.

Fabry Perot (FP) are used to measure strain, temperature and pressure. For this application they have been configured to measure accurate pressure in the annular space. They use a cavity which detects dimensional changes and related them to strain or pressure.

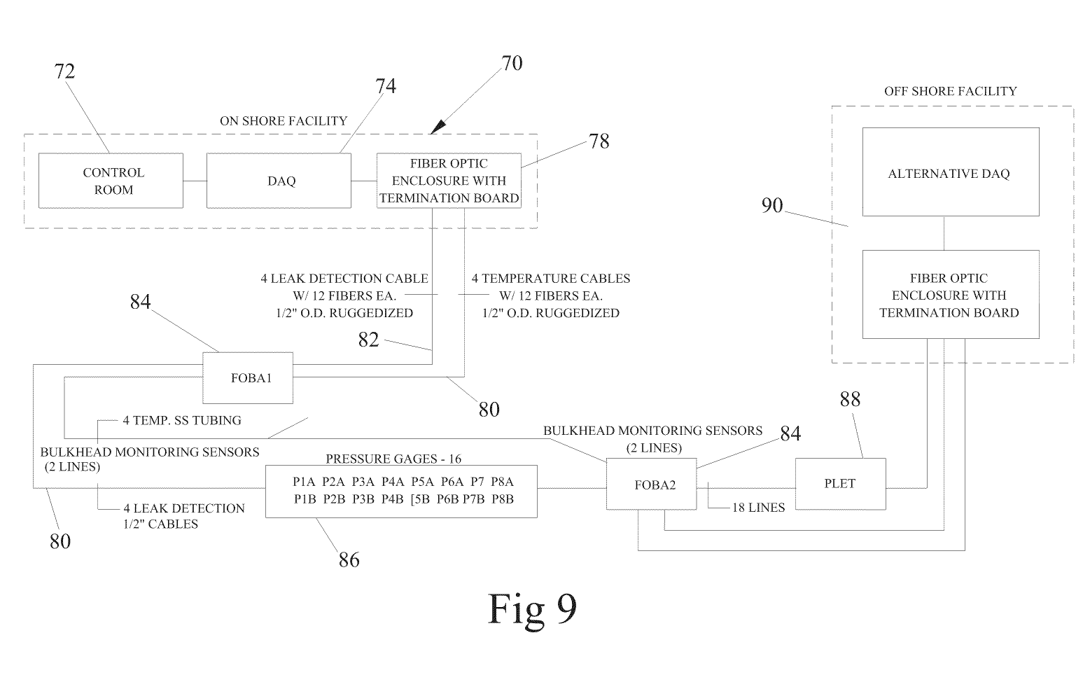

The monitoring system layout is shown in FIG. 9. The on shore facility 70 includes a control room or module 72 coupled to the document acquisition system (DAQ) 74 by the modbus 76. The DAQ is connected to the Fiber Optic Enclosure and Termination Board 78. Leak cables 80 and temperature cables 82 are coupled to the pipeline system through a coupler or fiber optic breakout assembly (FOBA) 84. In the example, the temperature sensor cables 82 are connected to the bulkhead sensors as shown at 84. The leak detection sensor cables 80 are connected to pressure gages 86 along the pipe, as indicated. The Product Line End Termination (PLET) 88 sensors are also connected to the DAQ 74 via the bulkhead coupler 84, as shown. An alternate or backup DAQ facility may be provided off-shore or elsewhere as indicated at 90.

Temperature and Leak Detection Locations

Routing of the sensors, ruggedization methods, and quantity for the example is shown in the drawings. The configuration for temperature monitoring includes four fiber optic fiber lines that are housed in stainless steel tubes. These tubes are attached directly to the inner LNG pipe and the LPG (24-inch) low carbon steel and the NGL cool-down (8¾-inch) low carbon steel pipe. Four additional fiber optic lines run through the annulus space and will be surrounded by aerogel. The fiber lines that are located in the annulus are housed in a polyethylene or polymethine jacketed steel reinforced cable and will detect leaks.

A cross section of the sensor placement and routing has been determined and is shown in the drawings, as will be discussed herein. The LNG and multi product pipelines are shown. The NGL cool-down pipe is similar to the multi product pipeline only smaller diameter and is not shown.

Pressure Sensor Locations

In the illustrated embodiment there are eight locations for pressure monitoring in the pipelines. The pressure sensors are configured to measure up to 100 psig. These are located in the annular space near the leak detection sensors and in close proximity to the vent line. The sensors breakout from extra fibers contained in the leak detection cables. Each of the eight pressure sensor stations contains two pressure gauges. One of the two pressure gauges is routed to the facility side of the cabling and the second pressure gauge is routed through the off loading terminal side of the cable. This configuration is used so that pressure measurement is always available even if a cable from either end is severed.

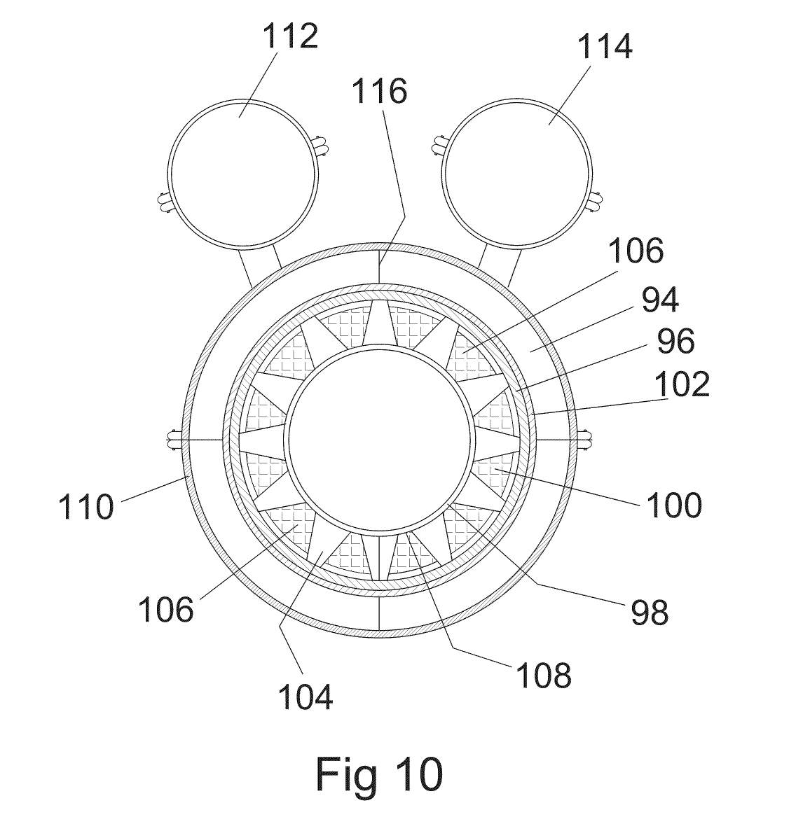

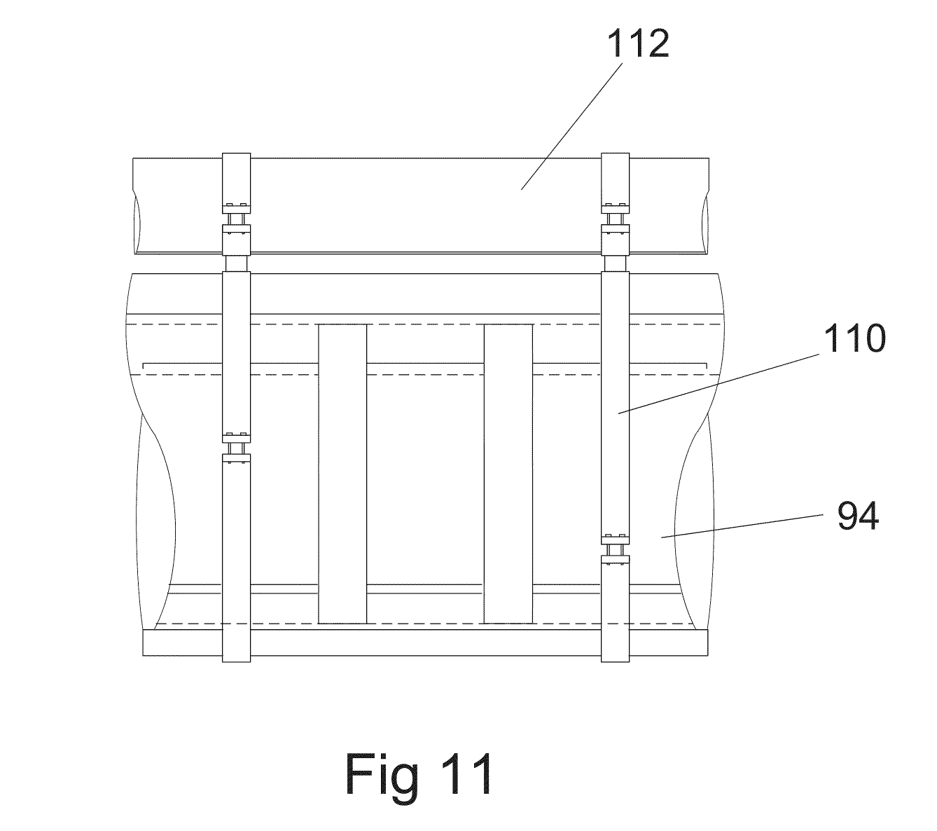

With specific reference to FIGS. 10 and 11, the LNG pipe assembly including the monitoring system of the subject invention has an outer concrete coating 94 surrounding an outer pipe 96. Concentric with the outer pipe is an inner pipe 98. The annulus between the inner pipe 98 and the outer pipe 96 is filled with the nanocel insulation 100. In the exemplary embodiment the outer pipe is covered with a Fusion Bonded Epoxy (FBE) corrosion coating between the pipe 96 and the concrete coating 94. A plurality of syntactic foam spacers 104 provide support and position the inner pipe 98 relative to the outer pipe 96. Fiber leak detection sensors 106 are embedded in the nanogel insulation. A leak is detected when a change in pressure in the annular space is experienced and sensed by one or more sensors. The temperature sensors 108 are also embedded in the nanogel insulation layer 100, but are positioned in close proximity or in actual contact with the outer wall of the inner pipe 98.

As shown in FIGS. 10 and 11, a plurality of circumferential clamps 110 are spaced along the axis of the pipe assembly for securing the pipe assembly to the temporary buoyancy pipes 112 and 114. Intrusion sensors 116 are positioned on the outer perimeter of the circumferential clamps 110. A vent tube 112 is provided for venting pressure build up.

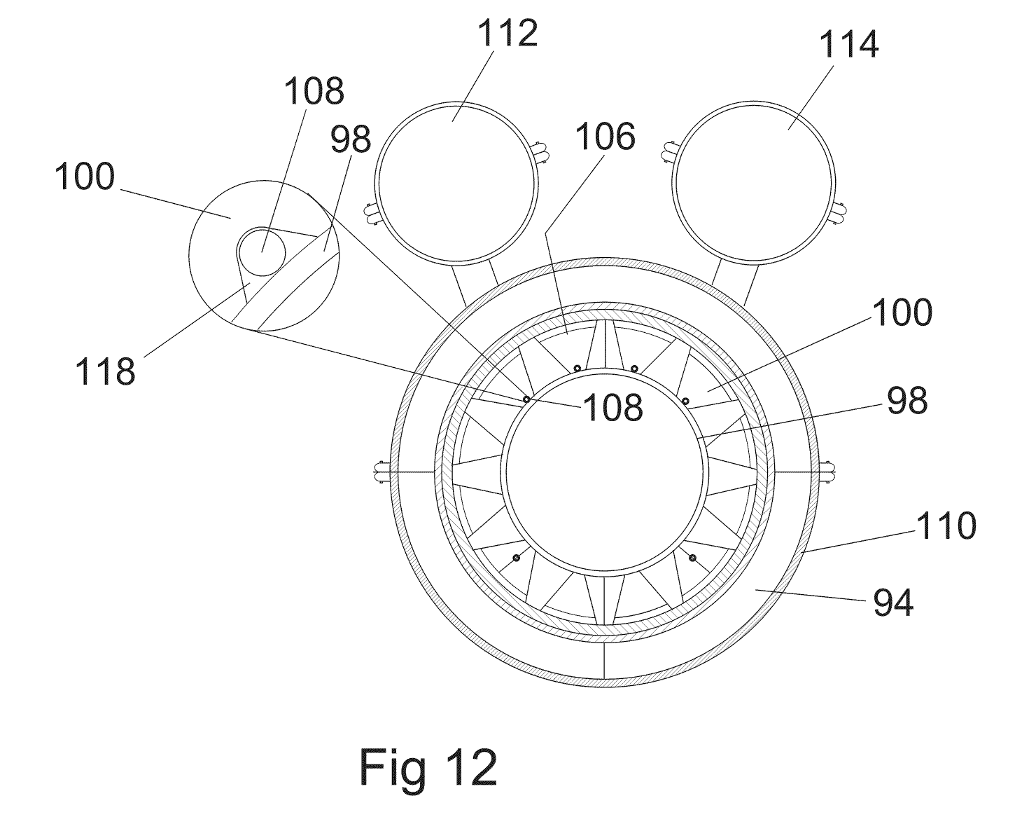

A partial enlarged view is shown in FIG. 12, illustrating the placement of the distributed temperature sensor (DTS) 108 in the nanogel layer 100 and secured in contact with the outer wall of inner pipe 98 by a low temperature epoxy 118.

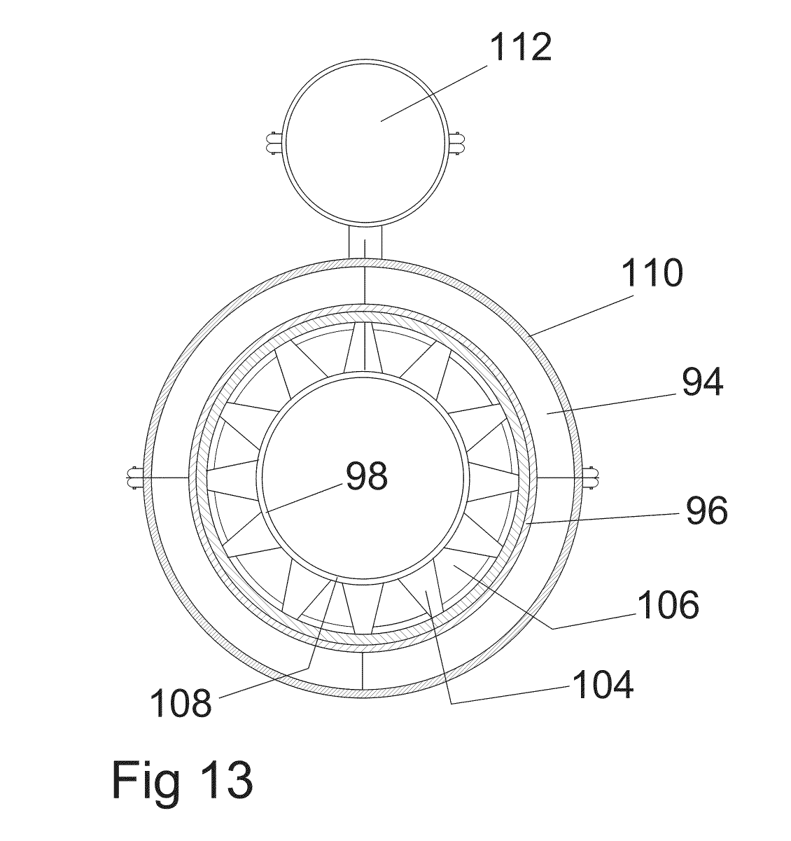

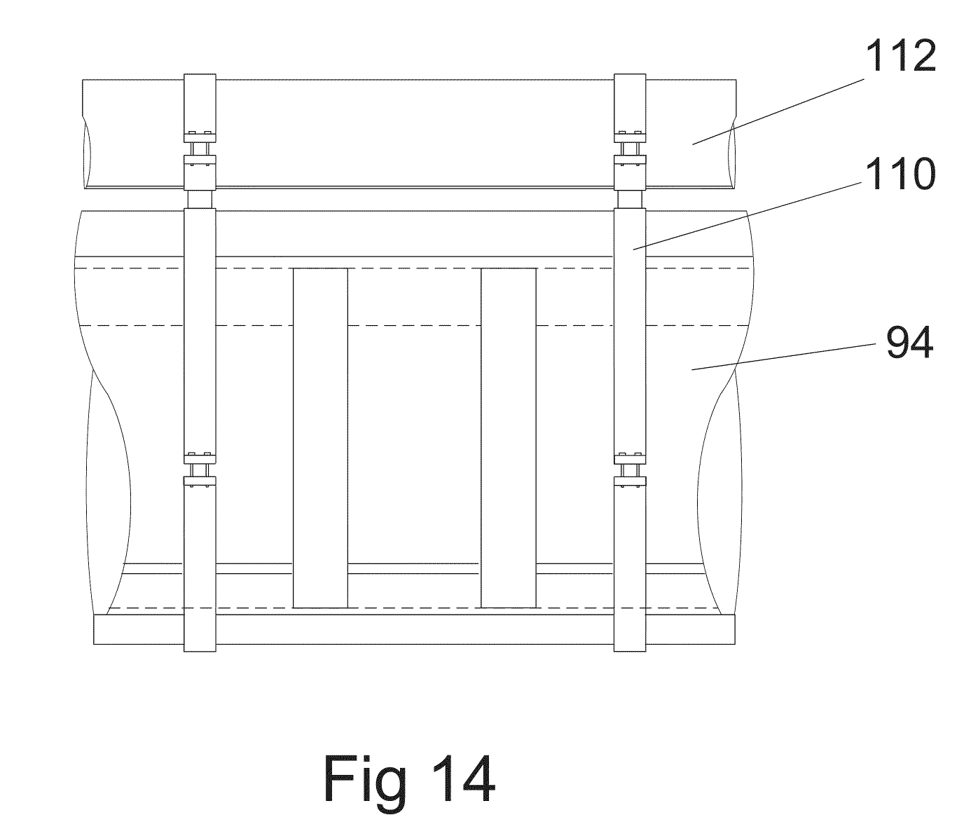

The product line pipe assembly is shown in FIGS. 13 and 14. The assembly is the same as for the LNG pipe and like numbers represent the same components. The differences are that the LNG inner pipe has an inner diameter of 32 inches whereas the inner pipe of the product line assembly has an inner diameter of 24 inches. Also, only a single temporary buoyancy pipe 112 is attached to the product line pipe system.

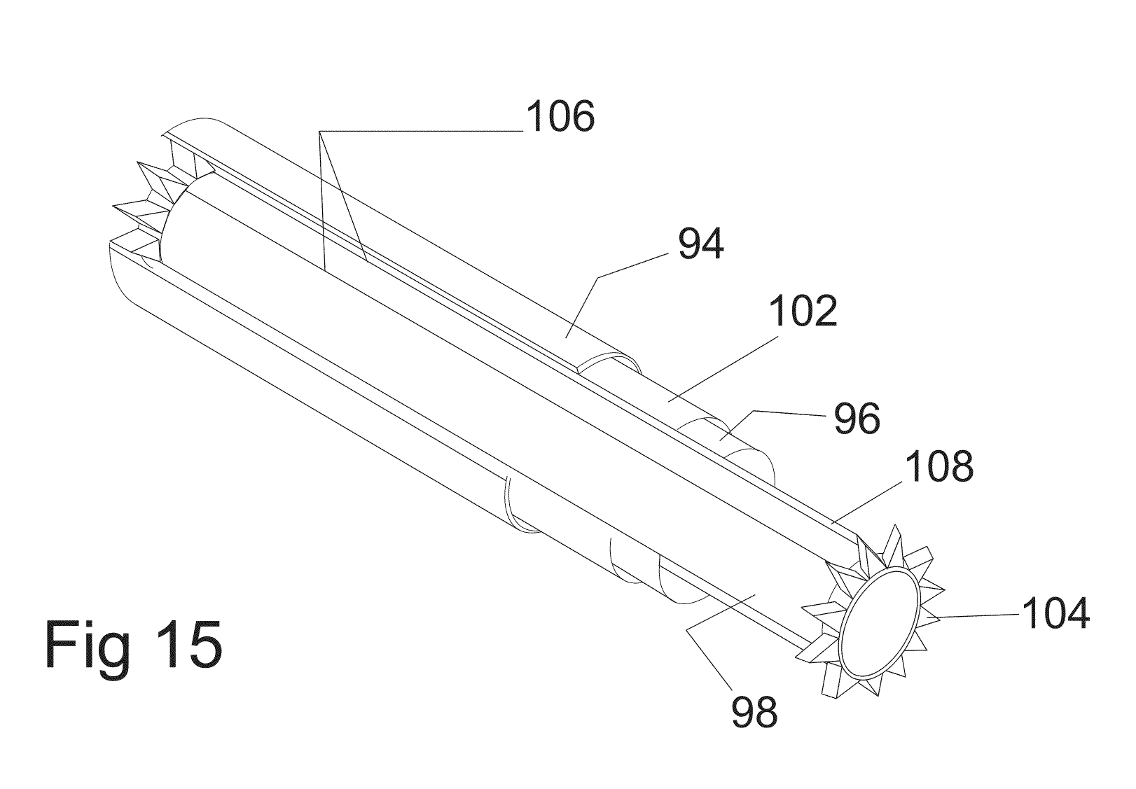

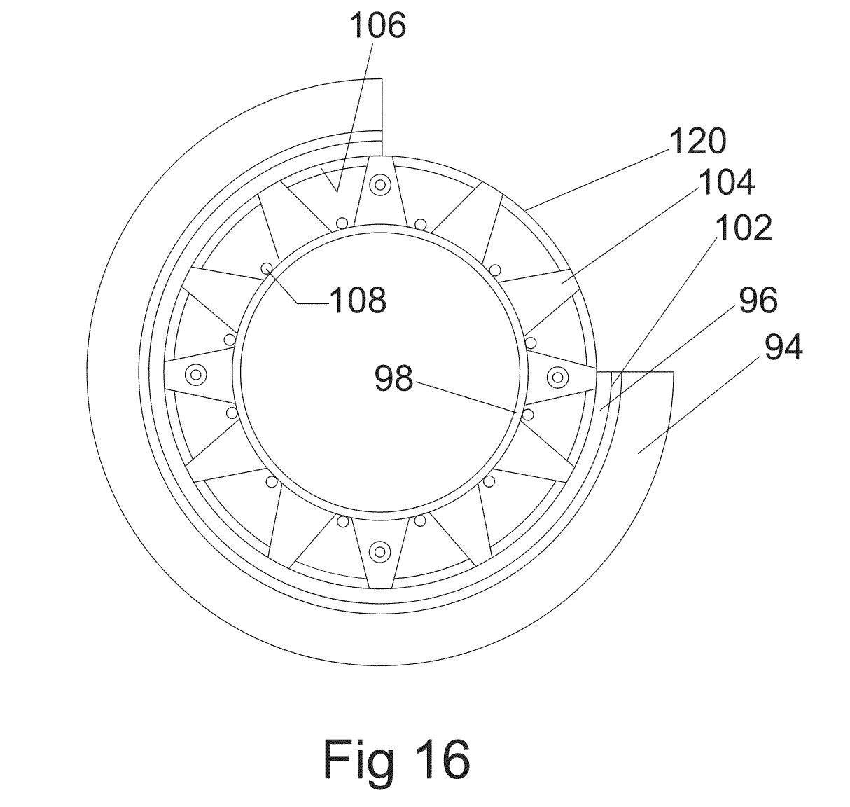

The routing of the temperature sensors along the longitudinal axis of the LNG pipe assembly is shown in FIGS. 15 and 16. Like reference numerals refer to like components in the earlier drawings. As shown in FIG. 15, the sensors are fiber optic cables running the length of the pipe, with the pressure sensors 106 imbedded in the nanogel insulation (here removed for clarity) and the leak detection sensors 108 positioned in contact with the outer wall of the inner pipe. As previously described, the longitudinal positioning of the sensors is a matter of choice along the length of the fiber optic cables. Note that FIG. 16 includes a spacer strap 120 for holding the spacers 104 in position during assembly.

Bulkhead Monitoring

The fiber optic monitoring cables include egress locations at the bulkheads.

The breakouts are accomplished through a Fiber Optic Breakout Assembly (FOBA) at each cable end. Details of the FOBA configurations are described in the next section of this report.

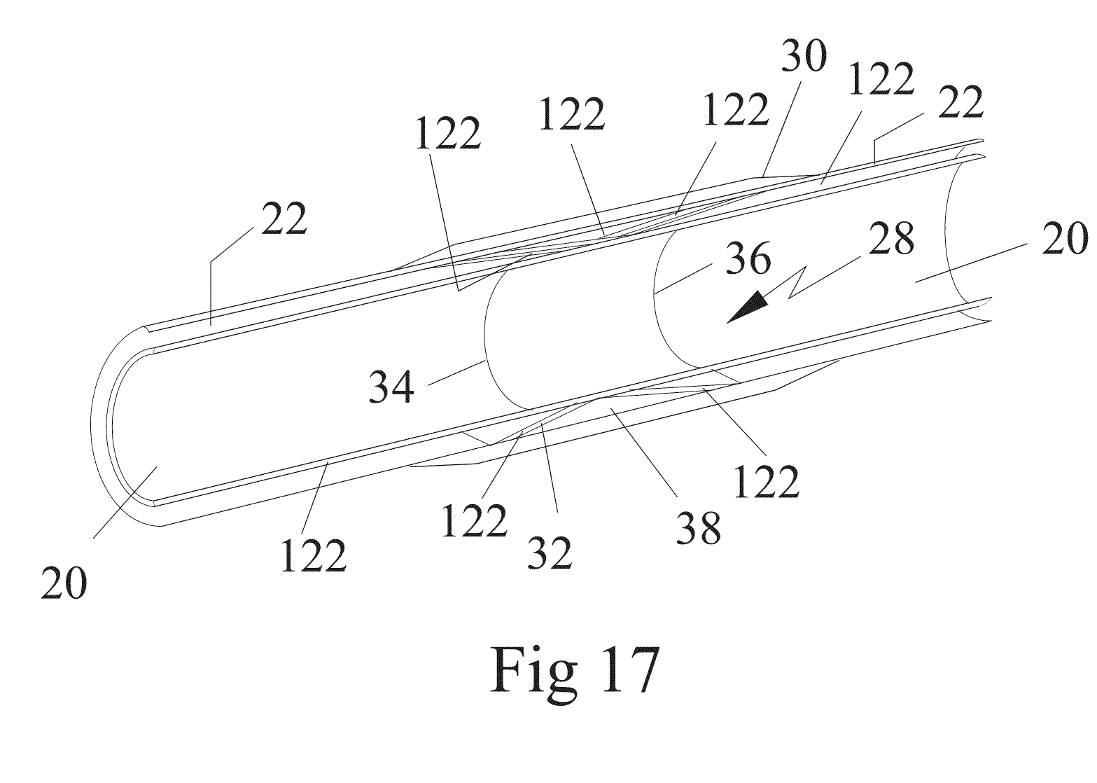

The bulkhead assembly of FIG. 17 is the same as that shown in FIG. 2. Like reference numeral are for the same components. FIG. 17 shows the positions of the sensors 122.

PLET Monitoring

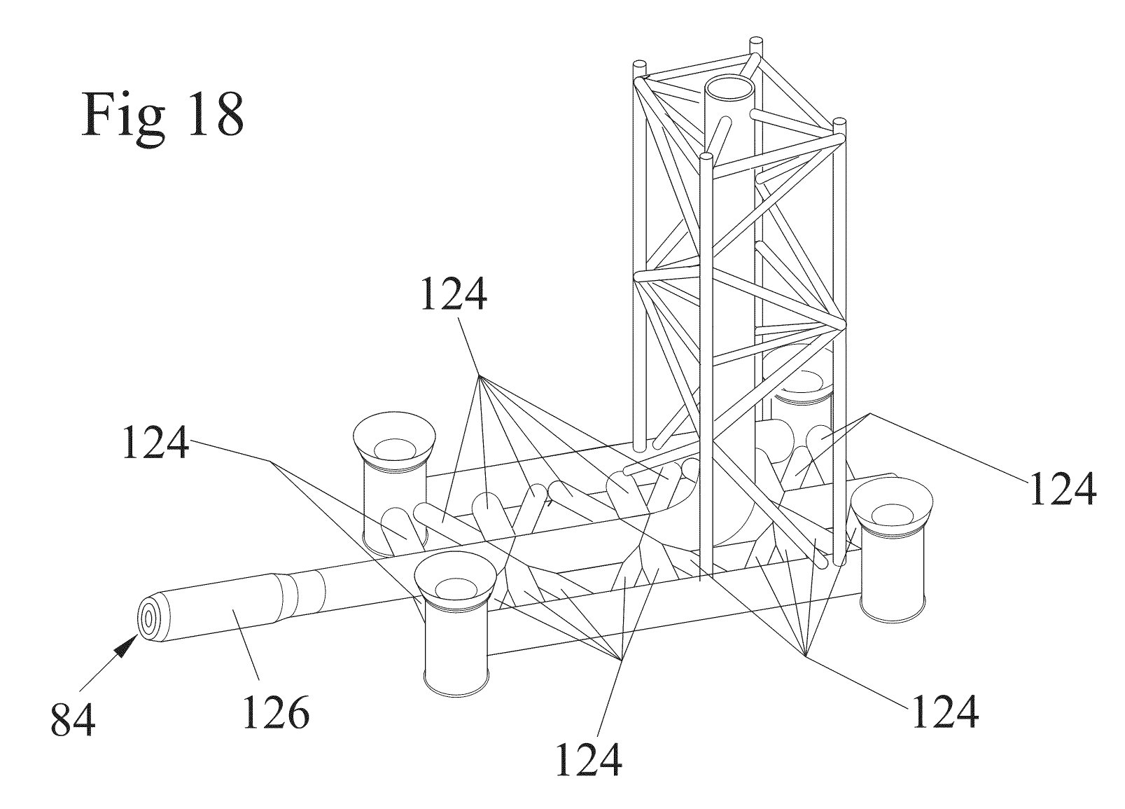

The pipeline end termination PLET structure includes structural monitoring modules bonded to the structural cross members. These sensors will measure hoop strain, axial strain, bending and torque. There are a total of eighteen cross members and each can be instrumented with FBG sensors (two hoop, four axial, two at 45 degree angle, and one temperature compensation gauge. The sensors are covered with a polyurethane layer. The positions of the PLET monitoring sensors 124 are shown in FIG. 18. The Fiber Optic Breakout Assembly (FOBA) 84 (see FIG. 9) is located at the end of the terminal bulkhead 126.

Polyimide coatings are used on all fiber lines throughout the monitoring system. This allows better long term monitoring characteristics. Polyacrylate is standard on telecom fibers. Polyimide forms a much stronger bond with the glass and will provide a much longer fiber life and more accurate data. The sensor and monitoring system design incorporates ruggedized cabling sufficient to survive handling and installation functions in the field.

The preferred method of joining fibers from one section to the next is fusion splicing. An alternate method of joining fibers is by use of multi-pin connectors.

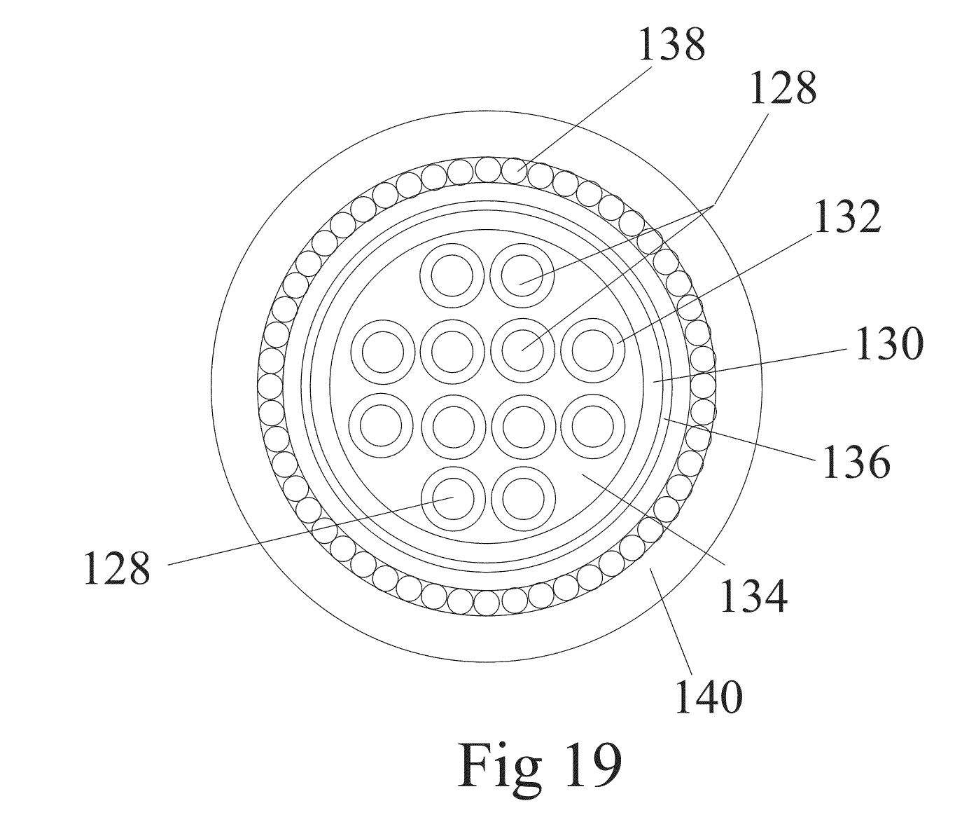

The external leak detection cable is shown in FIG. 19. It consists of multiple fibers 128 contained in a ruggedized jacket 130. Each fiber is carried in a buffer tube 132. The voids in the fiber assembly are filled with a scavenger gel 134. The stainless steel tube 130 is coated with a Nylon layer 136 and wrapped with steel reinforcement 138 to provide strength. The outside jacket 140 is Polyethylene which provides handling and scuff resistance.

The scavenger gel surrounding the fibers is a low temperature gel that contains hydrogen scavengers. This design not only provides rugged service but also long life where little if any attenuation loss will result from fiber darkening. In some applications no gel is required.

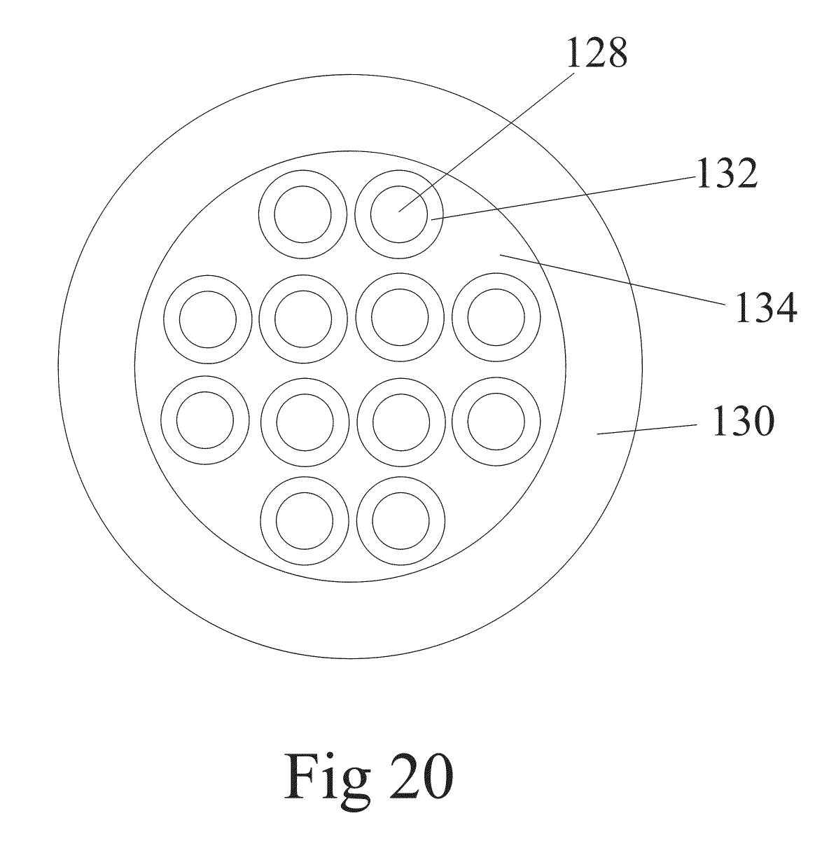

It should be noted that the temperature monitoring cables shown in FIG. 20 are identical except they contain no layers outside the stainless steel tubes.

At the bulkhead locations, see for example bulkhead 126 shown in FIG. 18, the topside and sensing cables will be joined by a fiber optic breakout assembly, see FOBA 84, FIGS. 9 and 18. The FOBA will also breakout the sensor fibers for bulkhead monitoring sensors 122 (FIG. 17) and for the PLET monitoring stations 124 (FIG. 18).

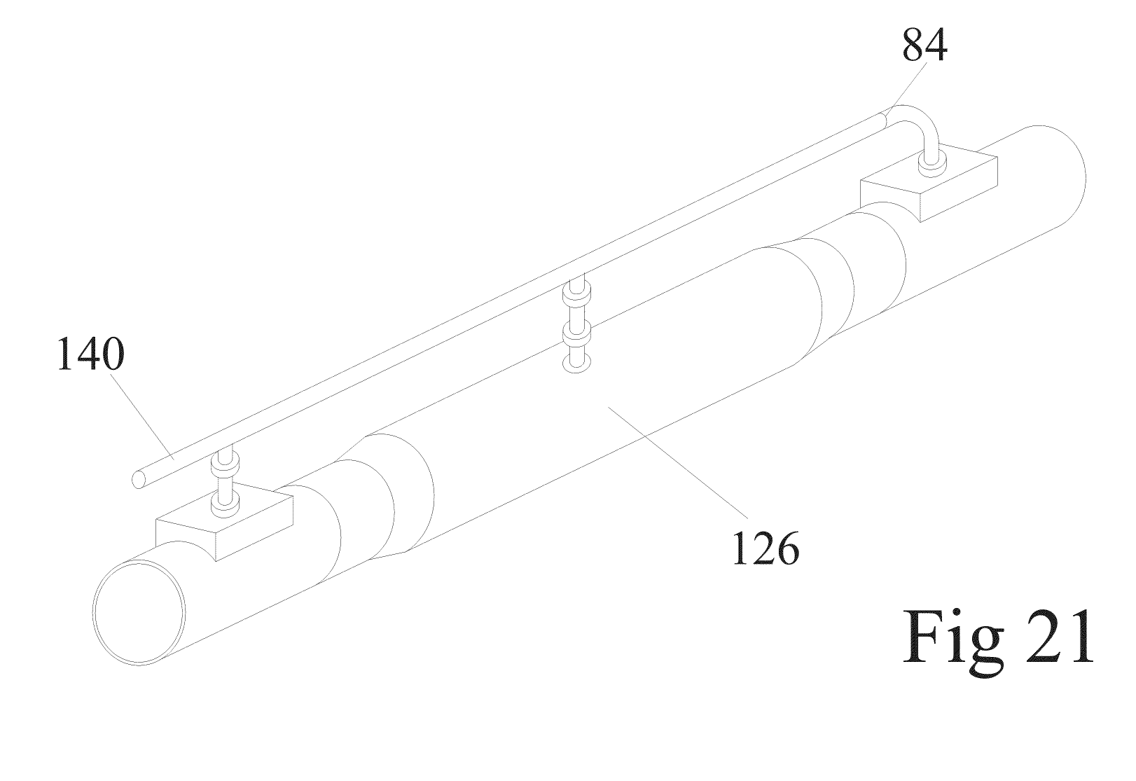

As shown in FIG. 21, the monitoring cables will egress the pipeline near the bulkhead assembly. The topside cables will be routed to the topside facility and topside off loading dock by cable trays. The junction of the topside and monitoring cables along with the breakout fibers will be housed in the two FOBAs 84, see FIGS. 9 and 21, located at each end of the pipelines. The preferred method of joining the cables is fusion splicing. The fusion splices are heat shrink wrapped to protect against breakage before introduction into the FOBA. Once encapsulated in the FOBA they are be protected from handling and operational damage. An alternate approach to join fibers is by the use of connectors. As with the fusion splice method, the connectors will be housed in the FOBA.

At the location where the monitoring cables egress from the pipeline and prior to the FOBA, a polyurethane seal is cast into place to prevent water intrusion into the annular space. It also seals in the aerogel and blocks any possible migration.

The PLET monitoring cables plus the temperature, pressure, strain and leak detection cables on the exit side of the FOBA are bundled and routed up the conduit that route through the PLET (see FIG. 18). All cables will be housed in tray 140 similar to that from the FOBA 84 (see FIG. 21). The cable tray will follow the pipeline upwards from Subsea to the fiber optic enclosure/termination box. From there the fibers will be routed to the off loading dock DAQ station 90 (see FIG. 9).

While certain features and embodiments have been described in detail herein it should be understood that the invention encompasses all modifications and enhancements within the scope and spirit of the following claims.

What is claimed is:

1. An fiber optic cable assembly comprising:
a. A plurality of fiber optic cables in general axial alignment;
b. An outer jacket for enveloping the cables; and
c. A gel-type material filling any void in jacket not filled by the fiber optic cables.

2. The fiber optic cable assembly of claim 1, wherein the gel-type material is a scavenger gel.

3. The fiber optic cable assembly of claim 2, wherein the scavenger gel contains hydrogen scavengers.

4. The fiber optic cable assembly of claim 3, wherein the scavenger gel is a low temperature gel.

5. The fiber optic cable assembly of claim 1, wherein the outer jacket is constructed of a rugged material which is of greater durability than the fiber optic cables.

6. The fiber optic cable assembly of claim 5, wherein the outer jacket is constructed of stainless steel.

7. The fiber optic cable assembly of claim 1, further comprising a protective outer layer surrounding the outer jacket.

8. The fiber optic cable assembly of claim 7, wherein the protective layer is constructed of Nylon.

9. The fiber optic cable assembly of claim 1, further comprising a reinforcing material surrounding the outer jacket.

10. The fiber optic cable assembly of claim 9, wherein the reinforcing material is a continuous winding.

11. The fiber optic cable assembly of claim 9, wherein a protective layer is placed on the outer jacket between the outer jacket and the reinforcing material.

12. The fiber optic cable assembly of claim 1, further comprising a protective outer layer enveloping the entire assembly.

13. The fiber optic cable assembly of claim 12, wherein the outer layer is constructed of polyethylene.

14. The fiber optic cable assembly of claim 12, wherein the outer layer is constructed of polyurethane.

15. The fiber optic cable assembly of claim 9, further comprising a protective outer layer surrounding the reinforcing material.

16. A subsea fiber optic cable system for monitoring a subsea pipeline, wherein sections of the pipeline are connected to one another at bulkheads, the fiber optic cable system further comprising:
a. A carrier for the fiber optic cable system, the carrier running generally coextensive with the pipeline;
b. Egress points for the fiber optic cable system positioned near each bulkhead.

17. The subsea fiber optic cable system of claim 16, wherein the carrier is a closed conduit.

18. A method for monitoring and maintaining a conduit utilizing a sensor assembly in communication with the conduit, the method comprising the steps of:
a. installing a monitoring system for measuring at least one parameter of interest, the monitoring system including a plurality of monitoring sensors placed at selected locations along the conduit;
b. taking a series of measurements using the monitoring sensors in near real time;
c. analyzing the measurements to identify anomalous conditions existing in the conduit being monitored;
d. and implementing corrective action based upon the real time measurement of the parameter of interest.

19. The method of claim 18, wherein the conduit is a pipe-in-pipe configuration containing an annular space.

20. The method of claim 19, wherein one of the annular spaces utilizes a partial vacuum for an insulating medium.

21. The method of claim 19, wherein one of the annular space is filled with a utilizes a nanoporous material.

22. The method of claim 19, wherein the annular space is filled with a microporous material.

23. The method of claim 19, wherein the annular space is filled with an aerogel

24. The method of claim 18, where the conduit is a pipe-in-pipe-in-pipe configuration containing two annular spaces.

25. The method of claim 24, wherein one of the annular spaces utilizes a partial vacuum for an insulating medium.

26. The method of claim 24, wherein one of the annular spaces is filled with a nanoporous material.

27. The method of claim 24, wherein one of the annular spaces is filled with a microporous material.

28. The method of claim 22, wherein one of the annular spaces is filled with an aerogel.

29. The method of claim 19, including the step of thermally insulating the assembly by filling the annular space with a thermal insulating material.

30. The method of claim 19, including the step of thermally insulating the assembly by providing a thermal insulating material on the exterior of the conduit.

31. A method for measuring the internal conditions of a subsea pipeline, comprising the steps of:
a. positioning sensors in communication with the pipeline at selected intervals along the pipeline length, and
b. reading the conditions monitored by the sensors at a remote location.

32. The method of claim 31, wherein the sensors are fiber optic sensors.

33. The method of claim 32, further including the step of providing an electric current to the sensors.

34. The method of claim 32, wherein the fiber optic sensors are positioned within the pipeline and are intrinsic based.

35. The method of claim 32, wherein the fiber optic sensors are positioned on the exterior of the pipeline and are extrinsic based.

36. The method of claim 32, wherein the fiber optic sensors are Fiber Brag Grating configurations.

37. The method of claim 32, wherein the fiber optic sensors are Fabry Perot configurations.

38. The method of claim 32, wherein the fiber optic sensors are distributed configurations.

39. The method of claim 38, wherein the distributed configurations utilize Brillouin scattering.

40. The method of claim 39, wherein the distributed configurations utilize Raman scattering.

41. The method of claim 32, wherein the fiber optic sensors utilize a combination of sensors along a single fiber optic line.
